(19) United States
(12) Patent Application Publication
(10) Pub. No.: US 2009/0127365 A1
(43) Pub. Date: May 21, 2009

(54) Bobbin, method of producing the bobbin, and method of producing fiber-reinforced plastic

(75) Inventors: Hiroshi Matsuo, Tokyo (JP); Takashi Kobayashi, Tokyo (JP)

Correspondence Address: Kubotera & Associates, LLC, Suite 202, 200 Daingerfield Road, Alexandria, VA, 22314, US

(73) Assignee: Toray Industries, Inc.

(21) Appl. No.: 12/292,166

(22) Filed: Nov. 13, 2008

Related U.S. Application Data
(60) Provisional application No. 60/996,422, filed on Nov. 16, 2007.

(51) Int. Cl. B65H 55/00; B65H 54/02; B05D 3/12

(52) U.S. Cl. 242/159; 242/470; 427/177

(57) ABSTRACT

A bobbin includes a reinforcing fiber bundle formed in a wound shape, and the reinforcing fiber bundle is formed of a plurality of filaments. The reinforcing fiber bundle includes a first twist having a first value T₁ per unit length (turn/m) at a first distance r₁ from a center axis of the bobbin, a second twist having a second value T₂ per unit length (turn/m) at a second distance r₂ from the center axis of the bobbin, and a third twist having a third value T₃ per unit length (turn/m) at a third distance r₃ from the center axis of the bobbin; said reinforcing fiber bundle is disposed so that the following relations are concurrently satisfied:

|T₁/2πr₁|≧|T₂/2πr₂|≧|T₃/2πr₃|

|T₁/2πr₁|>|T₃/2πr₃|

|T₁|≧|T₂|≧|T₃|≧0.5

where the first distance r₁, the second distance r₂, and the third distance r₃ are different from each other (r₁≠r₂≠r₃).

### CROSS-REFERENCE TO RELATED APPLICATIONS

This application claims the benefit under 35 U.S.C. 119(e) of the provisional application No. 60/996,422, filed on Nov. 16, 2007.

### BACKGROUND OF THE INVENTION AND RELATED ART STATEMENT

The present invention relates to a bobbin and a method of producing the bobbin. In the present invention, when a reinforcing fiber bundle is wound to form the bobbin, it is possible to reduce a twist of the reinforcing fiber bundle. The present invention further relates to a method of producing a fiber-reinforced plastic.

Reinforcing fibers such as glass fibers, aramid fibers, and carbon fibers have been combined with a thermosetting resin such as a vinyl ester resin and an epoxy resin, or a thermoplastic resin such as a polyamide resin to form a fiber-reinforced plastic. The fiber-reinforced plastic has been widely used in industrial applications such as sporting goods including golf goods, automobiles, ships, windmills, and aircrafts.

The reinforcing fibers are usually used in a form of a reinforcing fiber bundle made of a plurality of filaments. An intermediate material is formed from the fiber bundles, and then is formed in the fiber-reinforced plastic. As an example of the intermediate material, a semi-hardened resin is impregnated in the reinforcing fiber bundles to form a prepreg in a sheet shape. In this case, the prepreg is laminated in a specific number of layers, and then the lamination is heated to set, thereby forming the fiber-reinforced plastic. Alternatively, the reinforcing fiber bundle is formed in a dry sheet such as a fabric or a mat, and a resin is injected into the dry sheet, thereby directly forming the fiber-reinforced plastic.

When the reinforcing fiber bundle is converted to the intermediate material, or the reinforcing fiber bundle is directly converted to the fiber-reinforced plastic without the intermediate material, the reinforcing fiber bundle is generally supplied from a bobbin with the reinforcing fiber bundle continuously wound thereon. Accordingly, it is necessary to control a form or shape of the reinforcing fiber bundle supplied from the bobbin upon forming the intermediate material or directly forming the fiber-reinforced plastic.

Especially in these years, a size of the fiber-reinforced plastic has increased, and an amount of the reinforcing fiber bundles to use in one single molded article has increased. Accordingly, an amount of the reinforcing fibers, i.e. a necessary amount of the reinforcing fibers in the bobbin, has also increased.

Since the maximum amount of the reinforcing fiber bundle wound in each bobbin is limited, in order to continuously use a large amount of the reinforcing fiber bundles, it is necessary to use a large number of the bobbins together at once or necessary to use a large number of the bobbins connected at many times.

Especially when a large number of the bobbins thus connected are used, an inside-pull type bobbin is used for supplying the reinforcing fiber bundle from an inner layer side of the bobbin, thereby maintaining a factor affecting productivity such as a production of the intermediate material, an operation of a molding machine, and a supply of the reinforcing fiber bundles from the bobbins for a long period of time (refer to Patent Reference).

Patent Reference; Japanese Patent Publication No. 07-097138

In the inside-pull type bobbin, first, the reinforcing fiber bundle is wound around a core, i.e., a paper tube, of the bobbin, and then the core is removed from the bobbin. Then, the reinforcing fiber bundle is pulled out from the inner layer side of the bobbin upwardly or downwardly along an axial direction of the paper tube. At this time, the bobbin is placed on a flat table or the like, so that the axial direction of the paper tube is aligned with a vertical direction. Accordingly, the reinforcing fiber bundle is pulled out upwardly or downwardly in the axis direction.

In the method described above, when an end of the reinforcing fiber bundle in an outer layer side of the bobbin is connected to an end of the reinforcing fiber bundle in an inner layer side of another inside-pull type bobbin, it is possible to continuously supply the reinforcing fiber bundle while changing the bobbins.

When the reinforcing fiber bundle is supplied from the inner layer side of the inside-pull type bobbin, the bobbin itself does not rotate. Accordingly, when the reinforcing fiber bundle is pulled out as is in the axial direction of the paper tube, a twist is created in the reinforcing fiber bundle for one turn per one winding around the bobbin.

When the twist is created in the reinforcing fiber bundle, the filaments in the reinforcing fiber bundle tend to be disoriented from an original alignment, thereby lowering a reinforcing effect of the reinforcing fiber bundle in the fiber-reinforced plastic. In addition, when the reinforcing fiber bundle is twisted, a width of the reinforcing fiber bundle decreases. Accordingly, when the reinforcing fiber bundles are aligned and spread in a tape shape to form the intermediate material such as the prepreg or the textile, the twisted portion of the reinforcing fiber bundle may become a defect.

To solve the problem, for example, the bobbin may be rotated in a direction opposite to a direction of the twist so as to remove the twist. However, when the bobbin is rotated in this way, it is difficult to connect the reinforcing fiber bundle to that of another bobbin to be used next in advance. For this reason, it has been required to prevent the twist of the reinforcing fiber bundle, to stably maintain the orientation and the thread width of the reinforcing fiber bundle, and to continuously supply the reinforcing fiber bundle from a plurality of the bobbins.

In view of the above problems, an object of the present invention is to provide a bobbin capable of preventing a twist in a reinforcing fiber bundle thereof upon supplying the reinforcing fiber bundle from the bobbin, and to provide a manufacturing method of the bobbin. Another object of the invention is to provide a method of producing a fiber-reinforced plastic capable of maintaining a reinforcing effect of the reinforcing fiber bundle when the reinforcing fiber bundle is supplied from the bobbin.

### SUMMARY OF THE INVENTION

In order to attain the objects described above, according to the present invention, a bobbin includes a reinforcing fiber bundle formed in a wound shape, and the reinforcing fiber bundle is formed of a plurality of filaments. The reinforcing fiber bundle has a twist having an absolute value of at least 0.5 turn/m over a whole longitudinal direction thereof. The twist has a same direction over the whole longitudinal direction.

The reinforcing fiber bundle further includes a first twist having a first value T₁, a second twist having a second value T₂, and a third twist having a third value T₃ at a first distance r₁, a second distance r₂, and a third distance r₃ from a center axis of the bobbin, respectively. The reinforcing fiber bundle is provided so that the following relations are concurrently satisfied:

|T₁/2πr₁|≧|T₂/2πr₂|≧|T₃/2πr₃|

|T₁/2πr₁|>|T₃/2πr₃|

where the first distance r₁, the second distance r₂, and the third distance r₃ are different from each other (r₁ ≠r₂ ≠r₃).

According to the present invention, a method for producing a bobbin includes the steps of: pulling out a reinforcing fiber bundle having no twist from a core of a first bobbin; and winding the reinforcing fiber bundle on a paper tube to obtain a second bobbin as the bobbin.

According to the present invention, a method of producing a fiber-forced plastic includes the steps of: pulling out a reinforcing fiber bundle from a core of a bobbin in a direction to untwist the reinforcing fiber bundle; and impregnate a resin into the reinforcing fiber bundle.

In the present invention, even when the reinforcing fiber bundle is continuously supplied from the core portion of the bobbin, it is possible to obtain the reinforcing fiber bundle with substantially no twists. The reinforcing fiber bundle with the twists is wound to form the bobbin. When the reinforcing fiber bundle is pulled out from the bobbin, the reinforcing fiber bundle is untwisted. Accordingly, it is possible to reduce a variance in a width or thickness of the reinforcing fiber bundle without damaging or twisting the reinforcing fiber bundle.

In the present invention, the reinforcing fiber bundle has little twists, thereby eliminating an irregular orientation thereof, and making it easy to immerse a resin into the reinforcing fiber bundle. Accordingly, when the reinforcing fiber bundle is formed in a fiber-reinforced plastic, it is possible to prevent a reinforcing effect from lowering.

In the invention, when an end of the reinforcing fiber bundle is connected to an end of a reinforcing fiber bundle of another bobbin, it is possible to continuously supplying the reinforcing fiber bundle without stop in a molding process. The molding process may include protrusion, forming a prepreg, weaving, and most preferably, filament winding. In the molding process, a resin includes a thermosetting resin such as an epoxy resin and a vinyl ester resin and a thermoplastic resin such as polypropylene.

### BRIEF DESCRIPTION OF THE DRAWINGS

FIG. 1 is a schematic view showing a Bobbin A according to an embodiment of the present invention;

FIG. 2 is a schematic view showing the Bobbin A in a state that a reinforcing fiber bundle is pulled out therefrom according to the embodiment of the present invention;

FIG. 3 is a schematic view showing a Bobbin B according to the embodiment of the present invention;

FIG. 4 is a schematic view showing the Bobbin B in a state that a reinforcing fiber bundle is pulled out therefrom according to the embodiment of the present invention;

FIG. 5 is a schematic view showing the Bobbin A in a state that the reinforcing fiber bundle is wound around to form the Bobbin A according to the embodiment of the present invention;

FIG. 6 is a schematic view showing a method of producing the Bobbin B from the Bobbin A according to the embodiment of the present invention; and

FIG. 7 is a schematic view showing a method of filament winding using the Bobbin B according to the embodiment of the present invention.

### DETAILED DESCRIPTION OF THE PREFERRED EMBODIMENTS

Embodiments of the present invention will be explained with reference to the accompanying drawings.

In the following description, a reinforcing fiber bundle exhibits a reinforcing effect, and may include glass fibers, aramid fibers, and carbon fibers. Carbon fibers with high tensile strength are specially preferred. The carbon fibers may include PAN or pitch-based carbon fibers.

In the embodiments, the reinforcing fiber bundle made of a plurality of reinforcing fiber filaments is continuously wound around a core such as a paper tube of a Bobbin B. The core may be formed of any material. Since the reinforcing fiber bundle has to be fed from an inner side of the Bobbin B, the core is preferably formed of paper, so that the core can be easily removed after winding.

In the embodiments, the Bobbin B may have any size. Since it is necessary to connect the reinforcing fiber bundle to an end of a fiber bundle in the next bobbin, a large number of the bobbins have to be placed in a thread feeding area such as creel. Therefore, an outer diameter of the cores of the paper tubes may be preferably not larger than 100 mm.

When the outer diameter is too small, a radius of curvature may be too small depending on a type of the reinforcing fiber bundle, and the filaments of the fiber bundle may be damaged, so that the diameter is preferably at least 50 mm.

In the embodiment, the core may have any length, and may be selected based on easiness to remove from the bobbin before thread feeding.

In the embodiments, a twist is defined as a portion of the reinforcing fiber bundle twisted in a direction perpendicular to a longitudinal direction thereof, and one turn corresponds to a portion twisted by 360°. Further, the twist has a rotational direction, and an S-twist is defined as a portion twisted in a plus (+) direction and a Z-twist is defined as a portion twisted in a minus (−) direction relative to a direction from an inner layer to an outer layer of the bobbin.

In the embodiments, a Bobbin B is formed of a reinforcing fiber bundle. The reinforcing fiber bundle has a twist having an absolute value of at least 0.5 turn/m over a whole longitudinal direction thereof. The twist has a same direction over the whole longitudinal direction.

The reinforcing fiber bundle further includes a first twist having a first value T₁, a second twist having a second value T₂, and a third twist having a third value T₃ at a first distance r₁, a second distance r₂, and a third distance r₃ from a center axis of the bobbin, respectively. The reinforcing fiber bundle is provided so that the following relations (1) and (2) are concurrently satisfied:

|T₁/2πr₁|≧|T₂/2πr₂|≧|T₃/2πr₃| (1)

|T₁/2πr₁|>|T₃/2πr₃| (2)

where the first distance r₁, the second distance r₂, and the third distance r₃ are different from each other (r₁≠r₂ ≠r₃).

In the embodiments, one turn of the reinforcing fiber bundle corresponds to a length thereof wound along a circumference of the bobbin by 360°. It is assumed that one turn does not depend on a winding ratio. The winding ratio is defined as a number of windings of the reinforcing fiber bundle around the bobbin per one traverse from a start to an end of winding.

In the embodiments, when a winding condition such as the winding ratio is maintained constant, a length of one winding of the bobbin becomes larger as a radius r thereof increases. When the fiber bundle is supplied from the bobbin, the fiber bundle is untwisted by once turn per one winding. Therefore, the fiber bundle has a twist per unit length decreasing as the radius r increases.

More specifically, when the fiber bundle has a twist of T turn/winding at the radius r (m) from a center axis of the bobbin, a degree of the twist is expressed as T/2πr (turn/winding). The degree of the twist (T/2πr) decreases as the radius r increases. Accordingly, when different radii r1, r2, and r3 satisfy the equation (1), the radii meet an equation r1≦r2≦r3.

Further, the degree of the twist (T/2πr) changes at a different radius r, so that the radius r1 is smaller than the radius r3, and the degree of the twist (T/2πr) meets the equation (2).

In the embodiments, the equations (1) and (2) are expressed in the absolute values, which reflects the difference between the S-twist and the Z-twist. When the reinforcing fiber bundle is continuously supplied from the Bobbin B, the reinforcing fiber bundle is untwisted in a same direction, thereby forming the twist in a same direction over the whole longitudinal direction. For this reason, in one bobbin, the degree of the twist (T/2πr) becomes always plus or minus.

In the embodiments, when the reinforcing fiber bundle is continuously supplied from the Bobbin B, the reinforcing fiber bundle is untwisted. The absolute value of the twist of the reinforcing fiber bundle is greater than 0.5 turn/m over the whole length of the reinforcing fiber bundle.

In the embodiment, the reinforcing fiber bundle of the Bobbin B has twists having values t₁, t₂, and t₃ (turn/winding) per winding at positions r₁, r₂, and r₃ (r₁≠r₂≠r₃) from the center axis of the Bobbin B, and the values t₁, t₂, and t₃ are identical (t₁=t₂=t₃). Further, an absolute value of the twist is 0.5 to 1.5 turn/winding.

When the reinforcing fiber bundle is continuously supplied from the Bobbin B in a direction aligned with the axial direction of the Bobbin B, the reinforcing fiber bundle is twisted by ±1.0 turn/winding, thereby untwisting the twists mixed in the Bobbin B. If the reinforcing fiber bundle in the Bobbin B is twisted too much or too little, it is difficult to sufficiently untwist the reinforcing fiber bundle. Accordingly, it is preferred that the absolute value t of the twist is 0.5 to 1.5 turn/winding. It is necessary to supply the reinforcing fiber bundle from the Bobbin B in a direction aligned with the axial direction of the Bobbin B, so that the twist is untwisted.

In the embodiments, it is preferable that the reinforcing fiber bundle fed from the Bobbin B has no twist (0 turn/m) as possible. When the twist is close to 0 turn/m, it is possible to reduce an adverse influence of the twist on the reinforcing effect.

In the embodiments, the Bobbin B may not require a paper tube. Since the fiber bundle needs to be fed from an inner side of the Bobbin B, it is necessary to remove a core material such as a paper tube after winding. The Bobbin B can hold a wound form even after the core is removed.

The reinforcing fiber bundle may be formed of a specific number of reinforcing fiber filaments. A thicker fiber bundle tends to have more irregular bundle arrangement by the twist thereof, so that the number of the reinforcing fiber filaments is preferably 3,000 to 100,000, and more preferably 20,000 to 100,000.

The reinforcing fiber bundles are usually treated with a treatment agent such as a resin for easier handling. In the embodiment, it may not be necessary to adhere the treatment agent on the fiber bundles.

A method of manufacturing the Bobbin B of the reinforcing fiber bundle will be explained next.

In the embodiments, the Bobbin B may be obtained by re-winding the reinforcing fiber bundle pulled out from a core of a Bobbin A (another bobbin). A reinforcing fiber bundle with substantially no twists is wound around the core of the Bobbin A.

The Bobbin A is made using a winding device such as a publicly known winder so as not to mix a twist in the reinforcing fiber bundle. The reinforcing fiber bundle has substantially no twists including slight twists such as not greater than ±0.3 turn/m. When a winding machine winds the reinforcing fiber bundle without twists, the reinforcing fiber bundle may have twists depending on a portion in the longitudinal direction because of an influence of a yarn guide.

In the embodiments, the reinforcing fiber bundle may be pulled out from the core of the Bobbin A in either side of an axial direction thereof. Depending on the pull-out direction, the twist direction may be opposite between +(plus) and −(minus), so that the twist may be untwisted or worsened. When the reinforcing fiber bundle is pulled out from the core of the Bobbin A and wound around the core of the Bobbin B, it is preferred to prevent the twist from increasing or decreasing at a yarn guide in middle of the winding.

A relationship between the Bobbin A and the Bobbin B will be described next. It is preferred that the Bobbin A and the Bobbin B have the cores having a same outer diameter. When the reinforcing fiber bundle is pulled out from the Bobbin A, the reinforcing fiber bundle is twisted once along a circumference of the core. The twist is untwisted upon pulling out the reinforcing fiber bundle from the Bobbin B. Furthermore, the twists of the reinforcing fiber bundle maintain a frequency thereof upon pulling out the reinforcing fiber bundle from the Bobbin A, and it is preferred that the twists are efficiently untwisted upon pulling out the reinforcing fiber bundle from the Bobbin B. Accordingly, it is preferred that the Bobbin A and the Bobbin B have the cores having a same outer diameter.

Furthermore, the Bobbin A and the Bobbin B preferably have a same winding pattern. Accordingly, it is possible to pull out the reinforcing fiber bundle from the Bobbin A with the twists at a frequency same as that of the twists untwisted upon pulling out the reinforcing fiber bundle from the Bobbin B. The winding pattern may include a width of the reinforcing fiber bundle in the axial direction of the core, i.e. a winding width; a winding ratio; a reinforcing fiber length; and a winding shape.

When the Bobbin A and the Bobbin B have a same winding pattern, even when the Bobbin A and the Bobbin B have a large amount of the reinforcing fiber bundle, it is possible to efficiently untwist the twist of the reinforcing fiber bundle upon pulling out the reinforcing fiber bundle from the Bobbin A.

It is preferred that the reinforcing fiber bundle has the winding shape with a square-end, so that the Bobbin B can be stably placed on a table after removing the core.

A method of supplying the reinforcing fiber bundle from the Bobbin B will be explained next. In the embodiment, the reinforcing fiber bundle is pulled out from the core of the Bobbin B in a specific direction to untwist the twist. In the Bobbin B, the reinforcing fiber bundle has the twist in a same direction, i.e., +(plus) or −(minus). When the reinforcing fiber bundle is pulled out from the core of the Bobbin B, the reinforcing fiber bundle has the twist in one of the directions, i.e., +(plus) or −(minus), depending on which side in the axial direction the reinforcing fiber bundle is pulled out from.

When the reinforcing fiber bundle has the twist in the +(plus) direction, the reinforcing fiber bundle is pulled out from the side such that the reinforcing fiber bundle is twisted in the −(minus) direction. On the other hand, when the reinforcing fiber bundle has the twist in the −(minus) direction, the reinforcing fiber bundle is pulled out from the side such that the reinforcing fiber bundle is twisted in the +(plus) direction. By selecting the pulling-out direction as described above, the twists can be released in the process of feeding the fiber bundle from the core portion of the Bobbin B, and it is possible to use the reinforcing fiber bundle substantially without twists in a molding process.

In the embodiments, the reinforcing fiber bundle substantially without twists is supplied from the Bobbin B. Then, a resin is continuously supplied to the reinforcing fiber bundle, and immersed therein, thereby obtaining a fiber-reinforced plastic. The resin may be supplied before or after untwisting the twists, and the twists may be released preferably before feeding the resin because of easiness of untwisting.

Hereunder, the embodiment of the present invention will be described in more detail. In the embodiment, a carbon fiber bundle is used as the reinforcing fiber bundle.

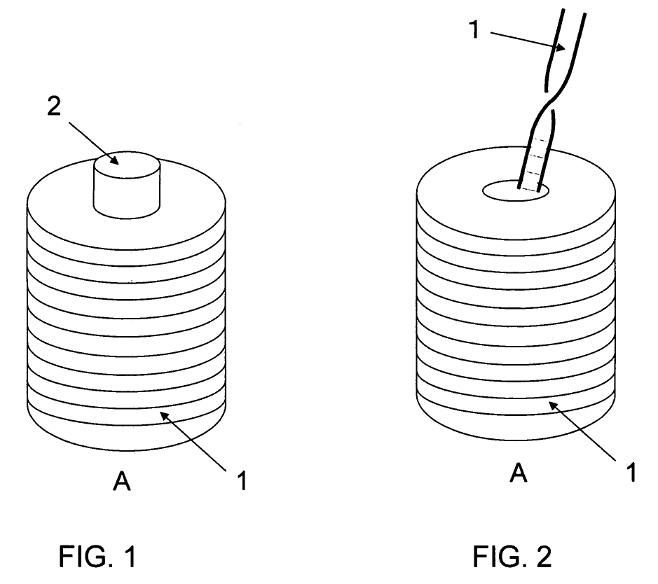

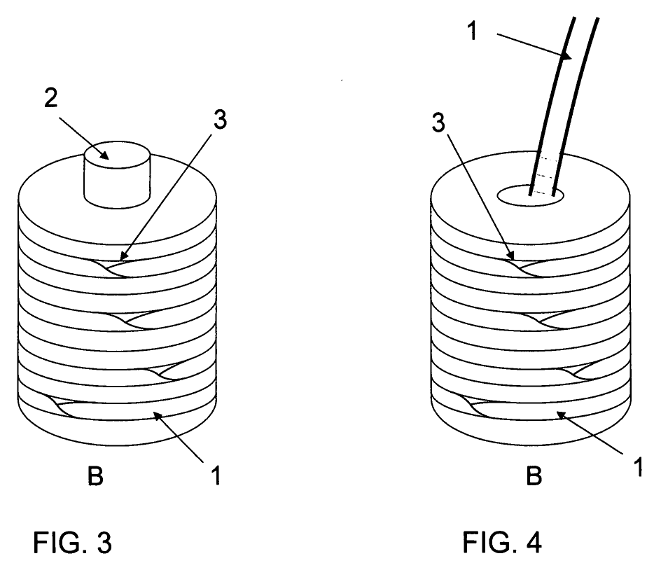

FIG. 1 is a schematic view showing the Bobbin A according to the embodiment of the present invention. FIG. 2 is a schematic view showing the Bobbin A in a state that a reinforcing fiber bundle is pulled out therefrom according to the embodiment of the present invention. FIG. 3 is a schematic view showing a Bobbin B according to the embodiment of the present invention. FIG. 4 is a schematic view showing the Bobbin B in a state that a reinforcing fiber bundle is pulled out therefrom according to the embodiment of the present invention.

In the embodiment, a carbon fiber bundle 1 is a none-twist carbon fiber (for example, TORAYCA® T700SC-24K-50C manufactured by Toray Industries Inc.). As shown in FIG. 1, the Bobbin A is formed of the carbon fiber bundle 1 substantially without twists continuously wound around an inner paper tuber 2. The paper tube 2 is an inside-pull type, and has a circular cross section with an outer diameter of 80 mm and a length of 280 mm. The carbon fiber bundle 1 is wound around the paper tube 2 over a winding length of 252 mm in an axial direction of the paper tube 2.

In the embodiment, as shown in FIG. 2, the carbon fiber bundle 1 is pulled out from the Bobbin A, so that the carbon fiber bundle 1 is wound around the paper tube 2 to form the Bobbin B (refer to FIG. 3). A whole portion of the carbon fiber bundle 1 of the Bobbin A is wounded to form the Bobbin B. The carbon fiber bundle 1 is supplied from an inner layer of the Bobbin A.

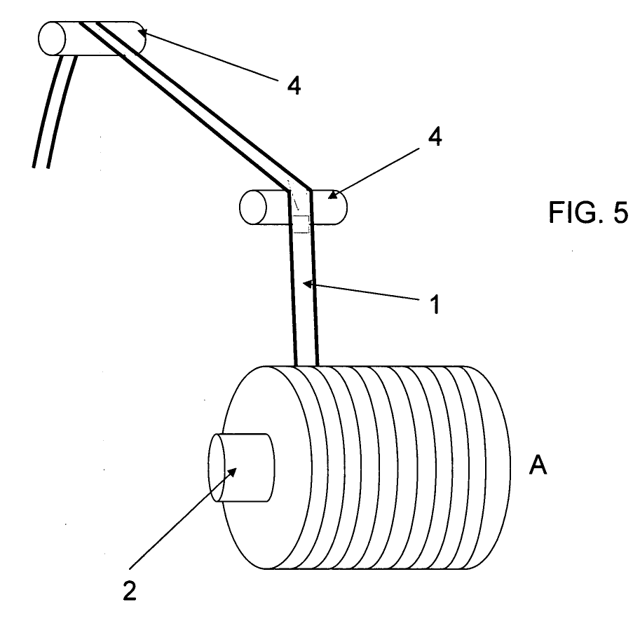

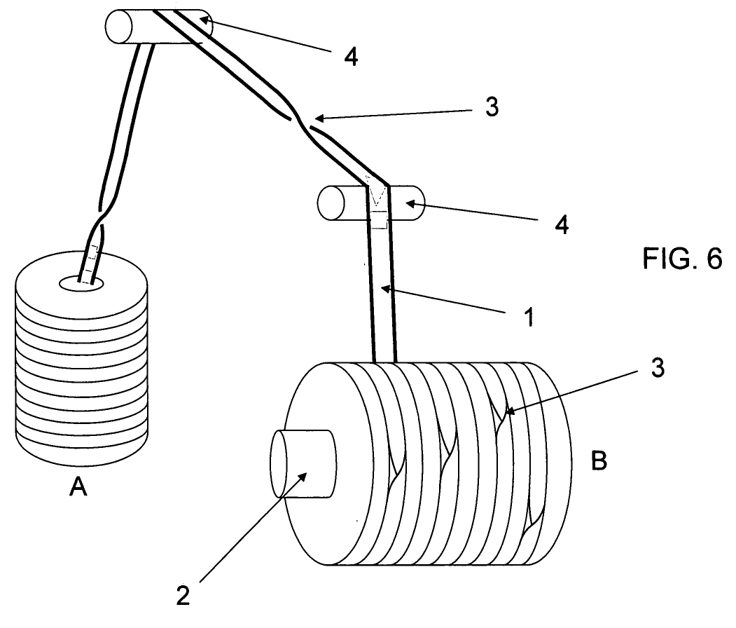

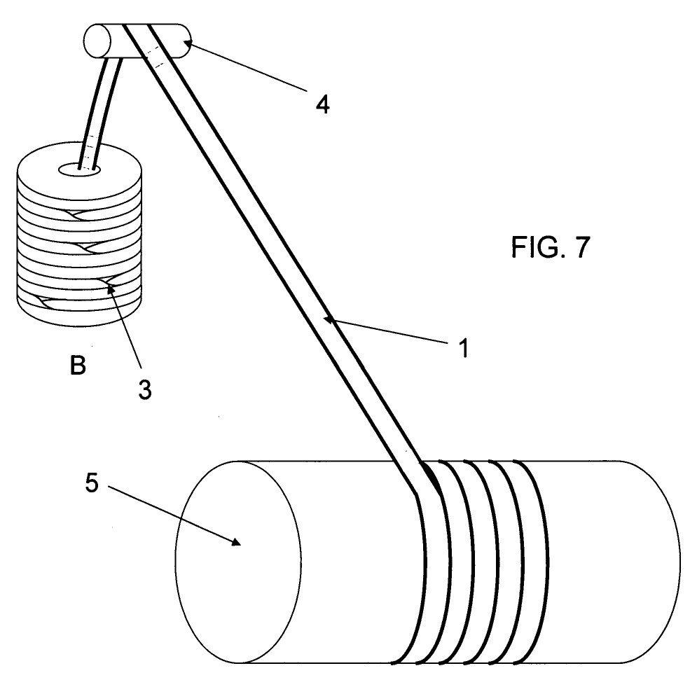

FIG. 5 is a schematic view showing the Bobbin A in a state that the reinforcing fiber bundle is wound round to form the Bobbin A according to the embodiment of the present invention. FIG. 6 is a schematic view showing a method of producing the Bobbin B from the Bobbin A according to the embodiment of the present invention.

As shown in FIG. 6, when the carbon fiber bundle 1 is pulled out from the Bobbin A, the Bobbin A is placed on a flat floor, and the carbon fiber bundle 1 is vertically pulled out upwardly from the inner layer of the Bobbin A. When the carbon fiber bundle 1 is wound around to form the Bobbin B, the carbon fiber bundle 1 slides against guides 4, so that the carbon fiber bundle 1 is not further twisted or twists do not accumulate.

As shown in FIG. 2, when the carbon fiber bundle 1 is pulled out from the Bobbin A, a twist 3 is generated in a direction from an inner layer side to an outer layer side of the Bobbin A. When the twist 3 is the s-twist (counterclockwise), a direction of the twist 3 is defined as +(plus). When the twist 3 is the Z-twist (clockwise), the twist 3 is defined as −(minus).

In the embodiment, the number of the twist 3 (turn) is measured as follows. First, the carbon fiber bundle 1 is cut in a 2 m long piece. One end portion (an end portion D) of the piece on an outer layer side in a longitudinal direction is fixed to a stable surface to be rotatable. The other end portion (an end portion C) of the piece on an inner layer side is in a hand, and is divided into two portions having a substantially equal carbon fiber amount.

When the piece is divided from the end portion C toward the end portion D, the end portion D rotates due to the twist 3 of the piece, and rotation of the end portion D is measured. The number of the twist 3 corresponds to a degree of the rotation of the end portion D when the piece is divided up to the end portion D.

For example, when the end portion D rotates 90° (0.25 times), the number of the twist 3 is defined as 1, and any rotation less than 90° (0.25 times) is ignored. Accordingly, when the rotation is 0.2 times, the number of the twist 3 becomes 0 turn. When the rotation is 0.85 times, the number of the twist 3 becomes 0.75 turns. Three pieces are continuously cut from one carbon fiber bundle, and an average of the three pieces is determined as the number of the twist 3. The number of the twist 3 is measured at a different radius of the Bobbin A through unwinding the carbon fiber bundle 1 to a position at the corresponding radius.

A first experiment was conducted for determining the number of the twist 3. After the paper tube 2 was removed from the Bobbin A having a weight of 6 kg and an outer diameter of 200 mm, the Bobbin A was placed on a flat floor such that the axial direction thereof was aligned with a vertical direction. The carbon fiber bundle 1 was pulled out from the inner layer side of the Bobbin A from one end side of the Bobbin A in the axial direction thereof, and the carbon fiber bundle 1 was continuously wound onto the paper tube to form the Bobbin B.

In this case, when the carbon fiber bundle 1 of the Bobbin B had the S-twist (twisted in the counterclockwise direction), the carbon fiber bundle 1 was pulled out from the Bobbin B such that the carbon fiber bundle 1 in twisted in an opposite direction (the clockwise direction) to form the Z-twist, thereby untwisting the carbon fiber bundle 1.

In the next step, after the paper tube was removed from the Bobbin B, the Bobbin B was placed on a flat floor such that an axial direction thereof was aligned with a vertical direction, and the carbon fiber bundle 1 was continuously pulled out from an inner layer side of the Bobbin B.

While the carbon fiber bundle 1 was continuously pulled out, three pieces having a length of 2 m were cut out from the carbon fiber bundle 1 at six winding positions of the Bobbin B having radii of 80, 95, 125, 150, 170, and 195 mm from an axis of the Bobbin B. Through the measurement described above, it was found that the numbers of the twists 3 were 0.08, 0.00, −0.06, 0.06, 0.03, and 0.03 (turn/m) at the six positions, respectively. Accordingly, it is confirmed that the carbon fiber bundle 1 continuously pulled out from the inner layer side of the Bobbin B had substantially no twists.

For comparison, the carbon fiber bundle 1 was continuously pulled out from an outer layer side of the Bobbin B, and the number of the twist 3 was measured in the same way as described above. As a result, it was found that the numbers of the twists 3 were 3.64, 3.39, 2.47, 2.28, 1.81, and 1.50 (turn/m) at the six positions, respectively.

Further, it was found that the numbers of the twists 3 per one winding were 0.91, 1.01, 0.97, 1.07, 0.96, and 0.92 turn/winding at the six positions, respectively. Accordingly, it is confirmed that the carbon fiber bundle 1 continuously pulled out from the outer layer side of the Bobbin B had substantial twists 3 gradually decreasing toward the outer layer side of the Bobbin B.

A second experiment was conducted for determining the number of the twist 3. In the second experiment, the carbon fiber bundle 1 was pulled out from the inner layer side of the Bobbin A from the other end side of the Bobbin A in the axial direction thereof, and the carbon fiber bundle 1 was continuously wound onto the paper tube to form the Bobbin B.

In the next step, after the paper tube was removed from the Bobbin B, the Bobbin B was placed on a flat floor such that the axial direction thereof was aligned with a vertical direction, and the carbon fiber bundle 1 was continuously pulled out from the inner layer side of the Bobbin B.

While the carbon fiber bundle 1 was continuously pulled out, three pieces having a length of 2 m were cut out from the carbon fiber bundle 1 at six winding positions of the Bobbin B having radii of 80, 95, 125, 150, 170, and 195 mm from an axis of the Bobbin B. Through the measurement described above, it was found that the numbers of the twists 3 were −0.14, 0.08, 0.03, −0.06, 0.11, and 0.08 (turn/m) at the six positions, respectively. Accordingly, it is confirmed that the carbon fiber bundle 1 continuously pulled out from the inner layer side of the Bobbin B had substantially no twists.

For comparison, the carbon fiber bundle 1 was continuously pulled out from an outer layer side of the Bobbin B, and the number of the twist 3 was measured in the same way as described above. As a result, it was found that the numbers of the twists 3 were −3.61, −3.03, −2.25, −1.86, −1.86, and −1.86 (turn/m) at the six positions, respectively.

Further, it was found that the numbers of the twists 3 per one winding were −0.96, −1.00, −0.88, −0.99, −0.96, and −1.11 turn/winding at the six positions, respectively. Accordingly, it is confirmed that the carbon fiber bundle 1 continuously pulled out from the outer layer side of the Bobbin B had substantial twists 3 gradually decreasing toward the outer layer side of the Bobbin B.

A third experiment was conducted for determining the number of the twist 3 of the Bobbin A for comparison. In the third experiment, the carbon fiber bundle 1 was pulled out from the outer layer side of the Bobbin A.

While the carbon fiber bundle 1 was continuously pulled out, three pieces having a length of 2 m were cut out from the carbon fiber bundle 1 at six winding positions of the Bobbin B having radii of 80, 95, 125, 150, 170, and 195 mm from an axis of the Bobbin B. Through the measurement described above, it was found that the numbers of the twists 3 were −0.08, 0, 0.11, 0.06, 0.11, and 0.06 (turn/m) at the six positions, respectively. Accordingly, it is confirmed that the carbon fiber bundle 1 continuously pulled out from the inner layer side of the Bobbin A had the twists 3 in both plus and minus directions.

Further, it was found that the numbers of the twists 3 per one winding were −0.02, 0, 0.04, 0.03, 0.06, and 0.03 turn/winding at the six positions, respectively.

Then, the carbon fiber bundle 1 was continuously pulled out from the inner layer side of the Bobbin A, and the number of the twist 3 was measured in the same way as described above. As a result, it was found that the numbers of the twists 3 were 4.08, 3.17, 2.53, 2.19, 1.75, and 1.53 (turn/m) at the six positions, respectively. Accordingly, it is confirmed that the carbon fiber bundle 1 continuously pulled out from the inner layer side of the Bobbin A had substantial twists 3 gradually decreasing toward the outer layer side of the Bobbin A.

FIG. 7 is a schematic view showing a method of filament winding using the Bobbin B according to the embodiment of the present invention.

As shown in FIG. 7, the Bobbin B is placed on a flat floor, and the carbon fiber bundle 1 is vertically pulled out upwardly from the inner layer of the Bobbin B. Then, the carbon fiber bundle 1 is wound around a mandrel 5. It may be arranged such that the carbon fiber bundle 1 passes through a resin bath (not shown), so that a liquid resin in the resin bath immerses into the carbon fiber bundle 1.

As shown in FIG. 7, when the carbon fiber bundle 1 is wound around the mandrel 5, the carbon fiber bundle 1 has substantially no twists. Accordingly, it is possible to easily impregnate the liquid resin into the carbon fiber bundle 1. Further, it is possible to reduce disorientation of the carbon fiber bundle 1. After the carbon fiber bundle 1 is wound around the mandrel 5, the mandrel 5 is placed in an over for curing the liquid resin, thereby obtaining a fiber-reinforced plastic.

As described above, in the embodiment of the present invention, even when the reinforcing fiber bundle is continuously supplied from the core portion of the bobbin, it is possible to obtain the reinforcing fiber bundle with substantially no twists. Accordingly, it is possible to reduce a variance in a width or thickness of the reinforcing fiber bundle without damaging or twisting the reinforcing fiber bundle.

In the embodiment of the present invention, the reinforcing fiber bundle has little twists, thereby eliminating an irregular orientation thereof, and making it easy to immerse a resin into the reinforcing fiber bundle. Accordingly, when the reinforcing fiber bundle is formed in a fiber-reinforced plastic, it is possible to prevent a reinforcing effect from lowering.

While the invention has been explained with reference to the specific embodiments of the invention, the explanation is illustrative and the invention is limited only by the appended claims.

What is claimed is:

1. A bobbin comprising a reinforcing fiber bundle formed in a wound shape, said reinforcing fiber bundle being formed of a plurality of filaments,
wherein said reinforcing fiber bundle includes a first twist having a first value T₁ per unit length (turn/m) at a first distance r₁ from a center axis of the bobbin, a second twist having a second value T₂ per unit length (turn/m) at a second distance r₂ from the center axis of the bobbin, and a third twist having a third value T₃ per unit length (turn/m) at a third distance r₃ from the center axis of the bobbin; said reinforcing fiber bundle is disposed so that the following relations are concurrently satisfied:

|T₁/2πr₁|≧|T₂/2πr₂|≧|T₃/2πr₃|
|T₁/2πr₁|>|T₃/2πr₃|
|T₁|≧|T₂|≧|T₃|≧0.5
where the first distance r₁, the second distance r₂, and the third distance r₃ are different from each other (r₁ ≠r₂ ≠r₃).

2. The bobbin according to claim 1, wherein said reinforcing fiber bundle has the first twist, the second twist, and the third twist all having a substantially identical fourth value per unit winding (turn/winding).

3. The bobbin according to claim 1, wherein said reinforcing fiber bundle has the first twist, the second twist, and the third twist all twisted in a same direction over a whole longitudinal direction thereof.

4. The bobbin according to claim 1, wherein said reinforcing fiber bundle is formed of the filaments in a number between 3,000 and 100,000.

5. The bobbin according to claim 1, wherein said reinforcing fiber bundle is formed of the filaments of carbon fiber.

6. A method for producing a bobbin comprising the steps of:
pulling out a reinforcing fiber bundle having no twist from a core of a first bobbin; and
winding the reinforcing fiber bundle on a paper tube to obtain a second bobbin as the bobbin.

7. The method of producing the bobbin according to claim 6, where, in the step of winding the reinforcing fiber bundle on the paper tube to obtain the second bobbin, said second bobbin has a winding ratio the same as that of the first bobbin.

8. The method of producing the bobbin according to claim 6, where, in the step of winding the reinforcing fiber bundle on the paper tube to obtain the second bobbin, said paper tube has an outer diameter the same as that of the first bobbin.

9. The method of producing the bobbin according to claim 6, where, in the step of winding the reinforcing fiber bundle on the paper tube to obtain the second bobbin, said reinforcing fiber bundle is wound on the paper tube over a length of the paper tube the same as that of the first bobbin along an axial direction of the paper tube.

10. A method of producing a fiber-forced plastic comprising the steps of:
pulling out a reinforcing fiber bundle from a core of a bobbin in a direction to untwist the reinforcing fiber bundle; and
impregnate a resin into the reinforcing fiber bundle.

11. The method of producing the fiber-forced plastic according to claim 10, further comprising the step of winding the reinforcing fiber bundle on a mandrel.

12. The method of producing the fiber-forced plastic according to claim 10, wherein, in the step of pulling out the reinforcing fiber bundle from the core of the bobbin, said reinforcing fiber bundle is pulled out in a direction opposite to a direction of a twist of the reinforcing fiber bundle.
